(19) United States
(12) Patent Application Publication
(10) Pub. No.: US 2006/0172261 A1
(43) Pub. Date: Aug. 3, 2006

(54) Method and system for facilitating the fabrication of a dental prosthetic at a dentist office in a single appointment

(76) Inventor: Edward G. Garry, Greenwood, IN (US)

Correspondence Address: MAGINOT, MOORE & BECK, LLP;CHASE TOWER, 111 MONUMENT CIRCLE, SUITE 3250, INDIANAPOLIS, IN, 46204, US

(21) Appl. No.: 11/049,822

(22) Filed: Feb. 3, 2005

(51) Int. Cl. A61C 5/00

(52) U.S. Cl. 433/215

(57) ABSTRACT

A system and method enable a dentist to fabricate a dental prosthetic that fits a restoration site in a patient's mouth in a single appointment without requiring the dentist to design the dental prosthetic. The system at the dentist office includes an acquisition unit, a milling unit, and a communication interface. The acquisition unit obtains image data of the restoration site while the patient is present in the dentist office. The communication interface sends the restoration site image data to a design center that is selectively coupled to a plurality of dentist offices. The restoration site image data is used at the design center by qualified personnel to design a prosthetic that corresponds to the imaged restoration site. Milling instructions are generated at the design center and sent to the communication interface at the dentist office. The milling unit executes the milling instructions to fabricate the dental prosthetic. In this manner, a patient may have a dental prosthetic designed, fabricated, and fitted in a single appointment without requiring the dentist to design dental prosthetic.

### FIELD OF THE INVENTION

The present invention relates generally to systems for fabricating dental prosthetics in a dental office, and more particularly, to dental prosthetic fabrication systems that include on-site design facilities.

### BACKGROUND OF THE INVENTION

Systems for making dental prosthetics in a dentist office are known. One such system includes an acquisition unit, a design station, and a milling unit that are all installed in the dentist office. The acquisition unit has a camera that is used to acquire three dimensional data of a restoration site in a patient's mouth. These image data are input to the design station of the prosthetic production system so the dentist or dental technician can display the image data and using tools available in the design station design a prosthetic for the restoration site. Once the design of the prosthetic has been completed, the design station generates a data file of milling instructions for machining the prosthetic. The data file is provided to the milling station and executed to control the operation of the milling station components to fabricate the prosthetic. The prosthetic is removed from the milling station and taken to the treatment room for installation in the patient's mouth. Thus, this system may be used to design, fabricate, and install a dental prosthetic in a single patient appointment.

The above-described dental prosthetic production system is most efficiently used when it is installed in a dental office. The use of the production system in a dentist's office, however, is not always preferred by the dentist because the learning curve for using the design station tools to design the prosthetic requires a significant investment of time. Only experienced dentists or dental technicians are able to design a prosthetic in a timely manner with an accurate fit. Consequently, many dentists prefer taking an impression of the restoration site and sending the impression by mail or courier delivery to a dental lab where a prosthetic production system has been installed. The turnaround time for designing and manufacturing a prosthetic after receipt of the impression at the dental lab is typically two weeks. Therefore, patients must schedule multiple appointments for restoration dental work. The first appointment enables a dentist to obtain an impression for the design of the prosthetic and subsequent appointments are used for installing and adjusting the prosthetic.

Even for those dentist offices at which a prosthetic production system is installed, the costs of having the system may be significant. The design of prosthetics during the learning period may not provide a good fit. Consequently, the dentist may have to spend more time and multiple appointments to ensure a good fit for the prosthetic. The time spent designing prosthetics may require patients to leave the dentist office before the prosthetic can be installed. In some offices, the dentist may delegate the learning of the design station operation to a technician. Once the technician becomes proficient in prosthetic design, the technician has a skill that is important for the dental practice. Illness of the technician can adversely impact the dental practice. The acquisition of the prosthetic design skills may promote job hopping for the technician or the threat of leaving the employ of a dentist may provide unreasonable leverage with office management regarding compensation for the technician. Training of additional technicians suffers from the learning curve costs noted previously and a dental practice may not be able to afford training more than one technician.

U.S. Pat. No. 6,835,006 describes a system that provides a design center so that design skills are not required by the in-office personnel of the dentist office. This system requires that an image of the restoration site be taken and then a measuring center having a measuring instrument be used to obtain measurement data. These measurement data are then communicated from the measuring center to a design center for design of a prosthetic. These design data are then communicated from the design center to a processing center where the design data are transmitted as processing commands to the milling unit for production of the dental prosthetic. The prosthetic is then delivered to the dental office for installation of the prosthetic.

This system suffers from a number of limitations. For one, a measuring center is required for obtaining the measurement data regarding the restoration site before data are sent to the design center. For another, the communication of the design data requires the conversion of the design data to the milling unit instructions at the processing center before the milling unit can produce the prosthetic. Additionally, the processing center in this system is not located at the dentist office so the delay of delivering the prosthetic to the dentist office still occurs. Therefore, a patient is required to make multiple appointments to be fitted with a dental prosthetic.

Consequently, there is a need for timely design and fabrication of a dental prosthetic in a dentist office without incurring the learning curve costs for prosthetic design.

### SUMMARY OF THE INVENTION

The present invention addresses the need for facilitating the in-office fabrication of a dental prosthetic in a dentist office in a single appointment without attendant learning curve costs or dependence on a small number of trained personnel. A system for enabling a dentist to fabricate on-site a dental prosthetic without requiring prosthetic design from the dentist comprises an acquisition unit located at a dentist office for acquiring image data for a restoration site in a patient's mouth, a milling station located in the dentist office at which the acquisition unit is located, the milling unit for fabricating a dental prosthetic, and a communication interface located at the dentist office that is coupled to the acquisition unit and the milling unit, the communication interface for sending the acquired restoration site image data from the acquisition unit to the design center for generation of milling instructions to fabricate a dental prosthetic that fits the restoration site for which the image data was acquired and for receiving the milling instructions from the design center and sending them to the milling unit. Such a system removes the requirement that the dentist or technician at the dentist office be able to operate a design station to design dental prosthetics, but still enables the dentist to fabricate the prosthetic at the dentist office during the patient's appointment. That is, the dentist is able to delegate the design aspect of the restoration work to a dental lab and still get timely turnaround of the milling instructions so the prosthetic may be fabricated at the dentist office and installed in a patent's mouth during a single patient appointment.

The communication interface of the system may be a computer network communication interface for sending the acquired image data from the acquisition unit to the design center over a computer network and for receiving the milling instructions at the milling station from the design center over the computer network. The communication interface is preferably an open network communication interface so that the acquired image data and the milling instructions are communicated between the dentist office and the design center over an open network. A well known example of an open network is the Internet.

In an alternative embodiment, the communication interface is a telephone network communication interface for sending the acquired image data from the dentist office to the design center and for receiving the milling instructions at the dentist office from the design center. In this embodiment, the communication between the dentist office and the design center is point to point communication. Such communication is not as susceptible to eavesdropping as open network communication is, however, if the telephone call is a long distance call, the costs of communication may be more than the costs of open network communication.

A design center that enables a plurality of dentist offices to obtain milling instructions for the fabrication of dental prosthesis that conform to image data of a restoration site taken in a dentist office includes a communication interface at a design center that is coupled to a plurality of dentist offices, the communication interface for receiving from each dentist office in the plurality of dentist offices image data of restoration sites in patients' mouths, each patient being imaged in one of the dentist offices in the plurality of dentist offices, a design station for using the received image data to design a dental prosthetic for the imaged restoration site and to generate milling instructions for the fabrication of the designed dental prosthetic at the dentist office, and the communication interface transmitting the generated milling instructions to the dentist office from which the restoration site image data was sent so that the designed dental prosthetic may be fabricated with a milling machine at the dentist office during a single patient appointment. Such a design center is capable of servicing many dentist offices in a timely manner for the production of dental prosthetics. The dentist offices are no longer required to own or operate a design station so the learning costs and reliance on a few personnel are avoided, but the dentist is able to fabricate timely a prosthetic so that a patient may be fitted in a single patient appointment. The design services of the dental lab, which are well-experienced with the tools of the design station, are utilized without the delay of intervening courier or mail services for delivery of the fabricated prosthetic.

The communication interface of the system may be a computer network communication interface for receiving image data from each dentist office in the plurality of dentist offices over a computer network and for transmitting over the computer network the milling instructions to the dentist office in the plurality of dentist offices that sent the image data to the design center. Preferably, the communication interface is an open network communication interface so that the image data and the milling instructions are communicated between the design center and the plurality of dentist offices over an open network, such as the Internet.

In an alternative embodiment of the design center system, the communication interface may be a telephone network communication interface for receiving the image data from one of the dentist offices in the plurality of dentist offices over a telephone network and for transmitting the milling instructions from the design center to the dentist office from which the image data was received. As noted previously, the telephone network enables point to point communication, which is less susceptible to eavesdropping, though perhaps at a greater financial cost.

A method for facilitating the fabrication of a dental prosthetic at a dentist office for a patient in a single appointment comprises imaging a restoration site in a patient's mouth being treated at a dentist office, transmitting the restoration site image data from the dentist office where the patient is located to a design center, receiving the restoration site image data at the design center, transferring the restoration site image data to a design station, designing a dental prosthetic that corresponds to the restoration site image data, generating milling instructions for the designed dental prosthetic, transmitting the milling instructions to the dentist office from which the restoration site image data was received, transferring the milling instructions to a milling machine located in the dentist office from which the restoration site image data was sent, fabricating with the milling machine under the control of the milling instructions received from the design center the designed dental prosthetic, and fitting the fabricated prosthetic in the mouth of the patient at the dentist office during the appointment in which the restoration site was imaged.

The transmission/reception of the restoration site image data and the transmission/reception of the milling instructions preferably occur over a computer network, and, more preferably, the communication of the restoration site image data and the milling instructions occurs over an open network, such as the Internet. If point to point communication is preferred, the transmission/reception of the restoration site image data and the transmission/reception of the milling instructions may be communicated over a telephone communication network.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a dentist office and a design center implemented in accordance with the principles of the present invention;

FIG. 2 shows a plurality of dentist office coupled to a design center in accordance with the principles of the present invention;

FIG. 3 shows a flow diagram of an exemplary method for facilitating the production of dental prosthetics using the systems of FIGS. 1 or 2;

FIG. 4 shows components of an exemplary camera that may be used to image a restoration site in a patient's mouth;

FIG. 5 shows the coupling of a camera support to the prismatic tube depicted in FIG. 4; and

FIG. 6 shows the use of the camera support to steady the camera for imaging a restoration site in a patient's mouth.

### DETAILED DESCRIPTION

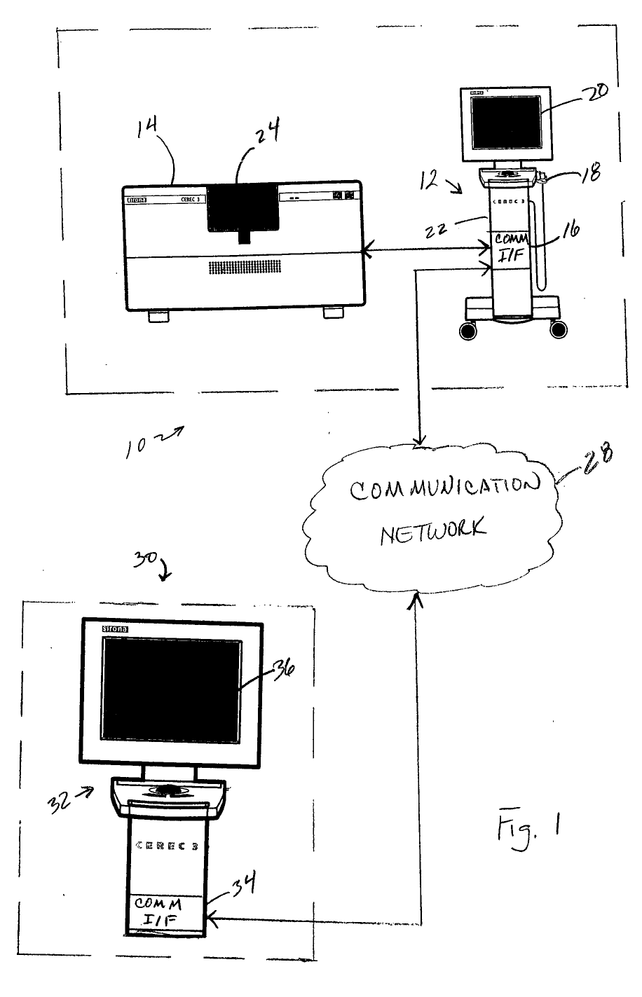

A dentist office 10 and a dental prosthetic design center 30 for facilitating the production of dental prosthetics in a single patient appointment without requiring the dentist to design a prosthetic are shown in FIG. 1. The dentist office 10 includes an acquisition unit 12 and a milling unit 14 coupled to a communication interface 16. The acquisition unit 12 includes a camera 18 for obtaining three-dimensional images of restoration sites inside a patient's mouth. The images may be displayed as video on the display 20 until the dentist confirms the image is one that is to be captured for preparation of a dental prosthetic. Located within the housing 22 is a computer for processing the camera images, managing the image data files, and administering the operation of the acquisition unit 12 and the milling unit 14.

Preferably, the acquisition unit 12 is a Cerec 3 acquisition unit available from Serona Dental Systems LLC of Charlotte, N.C. The display of such an acquisition unit is a 17 inch, flat, LCD display that is 1280×1024 pixels with SXGA resolution. The camera is a low noise CCD camera that generates an image of 680×480 pixels, each pixel being approximately 25×29 μm. The camera uses an infrared, polarized light source having a wavelength of 840 nm. The camera includes 8 MB of ultrafast SDRAM memory for an image acquisition memory and the images are processed at a rate of 1.4 million pixels/0.133 seconds. The maximum image data transfer rate from the camera is 38 MB/second. The computer within the housing 22 is a personal computer having an Intel Pentium 4 processor operating at 3 GHz that performs hyperthreading. The memory is a 4×512 MB DDR-RAM memory operating at 400 MHz. The computer includes a DVD/CD ROM drive, that is, preferably, a NEC ND-2500 combination drive as well as a 120 GB hard drive. The computer is controlled by a Windows XP Professional operating system. The computer also includes an Ethernet network card, a graphics card, and an audio card.

The milling unit 14 includes computer controlled milling tools for the fabrication of dental prosthesis from stock placed in the milling unit 14. Preferably, the milling unit 14 is a Cerec 3 milling unit manufactured by Sirona Dental Systems LLC of Charlotte, N.C. This unit is a six axis twin milling unit for simultaneously processing two restorations with two diamond burrs. Digital closed loop feed control is used for processing of the ceramic stock from which the dental prosthesis are made. Controls for calibrating each tool prior to milling are provided. The unit mills at a rate of approximately 0.4 to 0.6 mm/minute with a 12.5 mm step size and repeatability of ±30 μm. The milling unit includes a tapered 1.6 mm diamond having a 45° cone angle, a 1.6 mm cylindrical diamond, and a 1.2 mm cylindrical diamond. The diamonds have a 64 μm grain and they rotate at a speed of 40,000 rpm. The unit is controlled by a real time C167 microcontroller for two DC motor controls having integrated speed and current regulators. The milling unit includes a triangulation scanner for optical measurement of the prosthetic being milled. The scanner uses a low noise photodiode array and a 670 nm wavelength laser with a focal point diameter of ≦25 μm. The milling unit 14 is coupled to the acquisition unit 12 through an RS-232 cable typically provided for the COMM1 or COMM2 connectors of the computer in the housing 22. The ceramic stock is mounted within the milling chamber when the milling chamber door 24 is opened. The milling chamber door 24 may be transparent so that the milling of the ceramic stock may be viewed during prosthetic fabrication.

The communication interface 16 may be a computer network interface or a telephone network interface or both. In one embodiment, the communication interface 16 is a computer network interface that may couple the acquisition unit to a local area network (LAN) of computers within a dentist office. The LAN, in turn, may be coupled to a communication network 28 for the exchange of data with the design center 30. The LAN may be coupled through a telephone modem connection or a computer network connection through a T1, ISDN, or equivalent type line to an ISP provider or other computer network access portal. In this manner, the acquisition unit 12 may be coupled through the communication interface 16 to a computer network for communication with the design center 30. When the communication interface is an open network communication interface and an ISP is used, the acquisition unit 12 may be coupled to the Internet or other open network wide area network (WAN) for communication with the design center 30. Alternatively, the communication network 28 may be a proprietary or non-public computer network for coupling the communication interface 16 with the design center 30.

In another embodiment, the communication interface 16 is a telephone modem for coupling the communication interface 16 to an ISP through a telephone network and then through the ISP to the Internet for communication with the design center 30. In another embodiment, the telephone modem implementing the communication interface 16 may be used to communicate with a telephone modem implementing the communication interface 34 at the design center 30. This telephone to telephone communication may be used if point to point communication is preferred for security or other reasons. However, the preferred mode of coupling the dentist office 10 to the design center 30 is an open network communication interface so the Internet may be used for dentist office/design center communication. In this embodiment, an electronic mail program, such as Outlook Express, may be used at the dentist office to generate email messages with attachments for the design center and the design center 30 may also use an email program for communication with the dentist office.

The design center 30 includes at least one design station 32. The design station 32 is preferably a computer and display that is the equivalent of the computer and display of the data acquisition unit 12. The design station 32, however, executes the dental prosthetic design software that is no longer required for the acquisition unit at the dentist office. Also, the design station 32 does not require a camera as no patients are examined at the design center, although a camera may be included at a design station for other purposes. The communication interface 34 at the design center 30 is a communication interface that enables the design center 30 and the dentist office to communicate with one another through the communication network 28. Preferably, the communication interface 34 is a computer network interface and, more preferably, an open network interface, although the interface 34 may be a telephone interface or both as described above with regard to the communication interface 16. In a preferred embodiment, the design station 32 includes an email program for receiving email messages from the acquisition unit 12 with image data attachments for restoration sites imaged in the mouths of patients at the dentist office 10.

The image data files received from the acquisition unit 12 are displayed at the design station display 36 so a technician can use the tools provided by the dental prosthetic software to design a dental prosthetic that corresponds to the restoration site being displayed. These design tools are well-known and are provided in the Cerec 3 software. The design techniques and tools are described in the Cerec 3 Unit Manual available from Serona Dental Systems LLC of Charlotte, N.C. The disclosure of this Unit Manual is hereby expressly incorporated in its entirety by reference. Once the design of the prosthetic is complete, the design software generates milling unit instructions for operation of the milling unit 14 to fabricate the designed prosthetic. These instructions may 1960-0001 be included in attachments to email messages and returned to the dentist office through the communication interfaces 34 and 16. An image data file of the designed prosthetic may also be included with the milling unit instructions.

Upon receipt of the milling unit instructions, the dentist may transfer the milling unit instructions to the milling unit. The dentist may then load the ceramic block in the milling unit, close the milling chamber door, and activate the milling unit. In response, the milling unit executes the milling unit instructions that it has received through the communication interface 16. Prior to downloading the milling unit instructions to the milling unit 14, the dentist may display the image data file on display 20 to confirm the congruence of the designed prosthetic and the previously imaged restoration site. Once the milling machine has finished the fabrication of the prosthetic, the dentist may remove it from the milling unit and install it in the patient's mouth. The time for the communication of the restoration image data, the design of the prosthetic, the return of the milling unit instructions, and the fabrication of the prosthetic at the milling unit is sufficiently short that a patient is typically able to have the prosthetic installed in the same visit at which the restoration site is imaged.

A more robust embodiment of a system for facilitating the fabrication of dental prosthetics in a single appointment without requiring dentists to design prosthetics is shown in FIG. 2. In that figure, a plurality of dentist offices 10a, 10b, and 10c are coupled to a design center 30a through a communication network 28. Each of the dentist offices includes a data acquisition unit 12, a milling unit 14, and a communication interface 16 as previously described. The design center 30a is an expanded version of the design center 30 in FIG. 1. The design center 30a includes a plurality of prosthetic design stations 32a, 32b, and 32c that are coupled to a communication interface 34a. The communication interface 34a may be implemented on a computer that is separate from the computers for implementing the design stations. The communication interface 34a includes administration software for verifying the dentist office from which restoration image data are received has an existing account with the design center. The administration software may also enable a dentist office to setup an account with the design center, make payments, or handle other administrative aspects of account management. The administrative data for the dentist office accounts may be stored in database 38 and accessed by the communication interface 34a.

The system 40 shown in FIG. 2 enables the plurality of dentist offices to send restoration image data to the design center 30a through the communication interfaces at the offices and the communication network 28. After the communication interface 34a verifies the account and the account status, the restoration image data are provided to one of the design stations. There, a technician views the image data, measures structure from the image data, and designs a dental prosthetic. A prosthetic image data file and a milling unit instruction file are returned to the communication interface 34a. The administration application program of the communication interface 34a logs the activity, updates the account data, and may also archive the generated prosthetic image data and milling unit instruction file. The milling unit instruction file and prosthetic image data are then returned to the dentist office from which the restoration site image data was received. The prosthetic image data may be displayed at the dentist office to confirm the correspondence of the designed prosthetic to the imaged restoration site before sending the milling unit instructions to the milling unit at the dentist office for fabrication of the prosthetic. Thus, the system 40 enables a plurality of dentist offices to receive prosthetic design services from a single design center.

The system shown in FIG. 2 may be expanded with multiple design centers being coupled to the communication network 28 for servicing of the dentist offices. Preferably, the image data files described above with reference to the systems shown in FIGS. 1 and 2 are provided in the TIFF format, although other image data formats and data compression schemes may be used. The milling unit instruction files may be formatted in the proprietary format of the milling unit manufacturer. For the Cerec 3 milling unit, the milling unit instruction files are provided in a CDT or SDT formats.

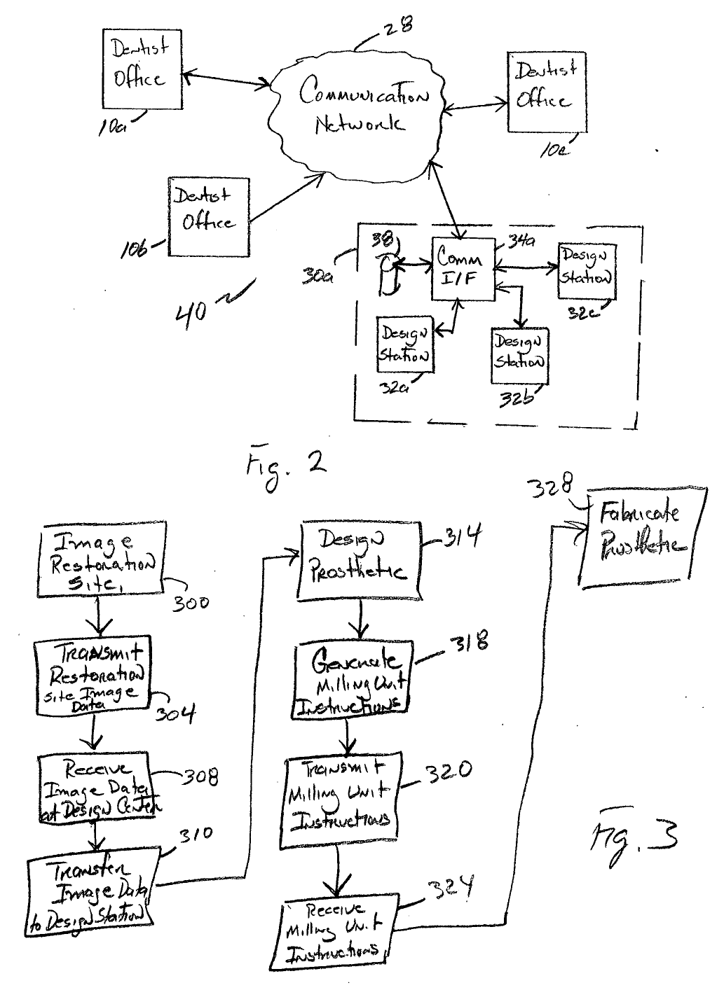

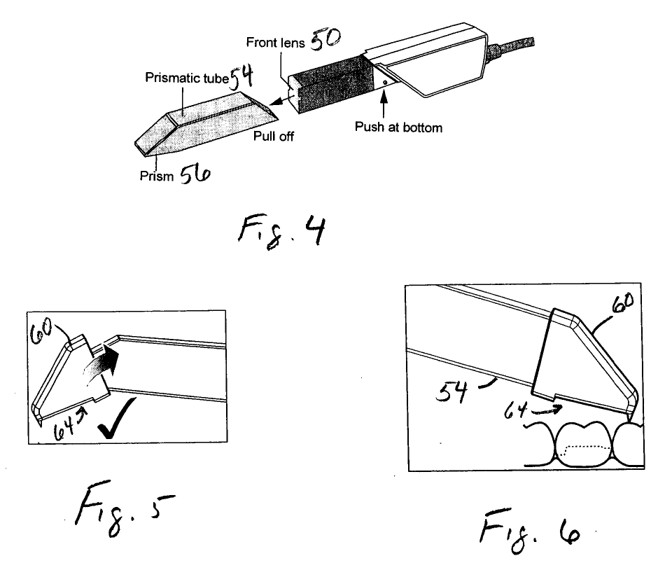

A method for facilitating the fabrication of a dental prosthetic at a dentist office for a patient in a single appointment is shown in FIG. 3. The method begins with the imaging of a restoration site in a patient's mouth at a dentist office (block 300). This imaging is preferably performed by preparing the restoration site with a thin, opaque coating to help ensure even light dispersion, reduce glare, and define a clear surface. These characteristics enable a high contrast image to be obtained so precise optical measurements may be made at the design center. The camera described above includes a front lens 50 over which a prismatic tube 54 may be placed to provide a prism 56 for the lens 50 as shown in FIG. 4. Also, a camera support 60 having an aperture 64 may be slipped over the tube 54 (FIG. 5) to better support the prism over the restoration site as shown in FIG. 6.

Once the restoration site has been imaged, the method continues by transmitting the restoration site image data from the dentist office where the patient is located to a design center (block 304, FIG. 3). The restoration site image data are received at the design center (block 308) and transferred to a design station (block 310). A dental prosthetic that corresponds to the restoration site image data is designed (block 314) and the milling instructions for the designed dental prosthetic are generated (block 318). The milling unit instructions are transmitted to the dentist office from which the restoration site image data was received and then transferred to a milling machine located in the dentist office from which the restoration site image data was sent (block 320). The milling unit instructions are received at the dentist office and transferred to the milling unit (block 324). Under the control of the milling instructions received from the design center, the milling unit then fabricates the designed dental prosthetic so that the prosthetic may be fitted to the patient at the dentist office in a single appointment (block 328).

In operation, a dentist obtains an acquisition unit, a milling unit, and a communication interface. The dentist then setups an account with a dental prosthetic design center. Thereafter, during a patient appointment, the dentist images a restoration site in a patient's mouth and sends the image data to the design center. The design center confirms the dentist office account and forwards the image data to a design station. A technician measures the restoration site features and designs a prosthetic. The design station generates the milling unit instructions for fabricating the designed prosthetic. After the account is updated for the design work, the milling unit instructions are returned to the dentist office where the instructions may be downloaded to the milling unit for fabrication of the dental prosthetic. The prosthetic may then be fitted on the patient.

While the present invention has been illustrated by the description of exemplary processes and system components, and while the various processes and components have been described in considerable detail, applicant does not intend to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

1. A system for enabling a dentist to fabricate on-site a dental prosthetic without requiring prosthetic design from the dentist comprising:
an acquisition unit located at a dentist office for acquiring image data for a restoration site in a patient's mouth;
a milling unit located in the dentist office at which the acquisition unit is located, the milling unit for fabricating a dental prosthetic; and
a communication interface located at the dentist office that is coupled to the acquisition unit and the milling unit, the communication interface for sending the acquired restoration site image data from the acquisition unit to a design center for generation of milling instructions to fabricate a dental prosthetic that fits the restoration site for which the image data was acquired, for receiving the milling instructions from the design center and sending them to the milling unit, and for communicating with administrative software executing at the design center for administrative management of a dentist office account.

2. The system of claim 1, the communication interface being a computer network communication interface for sending the acquired image data from the acquisition unit to the design center over a computer network and for receiving the milling instructions at the milling unit from the design center over the computer network.

3. The system of claim 2, the communication interface being an open network communication interface so that the acquired image data and the milling instructions are communicated between the dentist office and the design center over an open network.

4. The system of claim 1, the communication interface being a telephone network communication interface for sending the acquired image data from the dentist office to the design center and for receiving the milling instructions at the dentist office from the design center.

5. A system for enabling a plurality of dentist offices to obtain milling instructions for the fabrication of dental prosthesis that conform to image data of a restoration site taken in a dentist office comprising:
a communication interface at a design center that is coupled to a plurality of dentist offices, the communication interface for receiving from each dentist office in the plurality of dentist offices image data of restoration sites in patients' mouths, each patient being imaged in one of the dentist offices in the plurality of dentist offices, the communication interface also including administrative software for verifying that a dentist office sending restoration site image data has an account with the design center;
a design station for using the received image data to design a dental prosthetic for the imaged restoration site and to generate milling instructions for the fabrication of the designed dental prosthetic at the dentist office; and
the communication interface transmitting the generated milling instructions to the dentist office from which the restoration site image data was sent so that the designed dental prosthetic may be fabricated with a milling machine at the dentist office during a single patient appointment.

6. The system of claim 5, the communication interface being a computer network communication interface for receiving image data from each dentist office in the plurality of dentist offices over a computer network and for transmitting over the computer network the milling instructions to the dentist office in the plurality of dentist offices that sent the image data to the design center.

7. The system of claim 6, the communication interface being an open network communication interface so that the image data and the milling instructions are communicated between the design center and the plurality of dentist offices over an open network.

8. The system of claim 5, the communication interface being a telephone network communication interface for receiving the image data from one of the dentist offices in the plurality of dentist offices and for transmitting the milling instructions from the design center at the dentist office from which the image data was received.

9. A method for facilitating the fabrication of a dental prosthetic at a dentist office for a patient in a single appointment comprising:
imaging a restoration site in a patient's mouth being treated at a dentist office;
transmitting the restoration site image data from the dentist office where the patient is located to a design center;
receiving the restoration site image data at the design center;
verifying account data for the dentist office from which restoration site image data was received upon receipt of the restoration site image data.
transferring the restoration site image data to a design station upon verification of the account data for the dentist office;
designing a dental prosthetic that corresponds to the restoration site image data;
generating milling instructions for the designed dental prosthetic;
transmitting the milling instructions to the dentist office corresponding to the verified account data;
transferring the milling instructions to a milling machine located in the dentist office from which the restoration site image data was sent;
fabricating with the milling machine under the control of the milling instructions received from the design center the designed dental prosthetic; and
fitting the fabricated prosthetic in the mouth of the patient at the dentist office during the appointment in which the restoration site was imaged.

10. The method of claim 9, the transmission/reception of the restoration site image data and the transmission/reception of the milling instructions between the design center and the dentist office corresponding to the verified account data being communicated over a computer network.

11. The method of claim 10, the communication of the restoration site image data and the milling instructions between the design center and the dentist office corresponding to the verified account data being over an open network.

12. The method of claim 9, the transmission/reception of the restoration site image data and the transmission/reception of the milling instructions between the design center and the dentist office corresponding to the verified account data being communicated over a telephone communication network.

13. The method of claim 9 further comprising:
coupling a plurality of dentist offices to the design center;
receiving restoration site image data from the plurality of dentist offices;
verifying account data for each dentist office from which restoration site image data are received;
designing dental prosthetics that correspond to the restoration site image data received from each dentist office for which account data was verified;
generating milling instructions for each designed dental prosthetic;
transmitting the milling instructions for a designed dental prosthetic to the dentist office in the plurality of dentist offices from which the restoration site image data was received;
fabricating with the milling machine under the control of the milling instructions received from the design center the designed dental prosthetic at the dentist office from which the restoration site image data was received; and
fitting each fabricated prosthetic in the mouth of the corresponding patient at the dentist office where the restoration site was imaged during the appointment in which the restoration site was imaged.

14. The method of claim 9, the account verification further comprising:
verifying an account status for the dentist office from which restoration site image data was received upon receipt of the restoration site image data.

15. The method of claim 14 further comprising:
updating account data for the dentist office from which restoration site image data was received with design activity data before transmitting the milling instructions to the dentist office from which restoration site image data was received.

16. The method of claim 14 further comprising:
archiving the restoration site image data and the milling instructions at the design center before transmitting the milling instructions to the dentist office from which restoration site image data was received.
